(19) United States
(12) Patent Application Publication
(10) Pub. No.: US 2008/0084829 A1
(43) Pub. Date: Apr. 10, 2008

(54) Apparatus, method and computer program product providing link adaptation

(75) Inventor: Samuli Visuri, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/544,413

(22) Filed: Oct. 5, 2006

(51) Int. Cl. H04L 12/26

(52) U.S. Cl. 370/252

(57) ABSTRACT

A method includes: for a selected modulation type and coding rate, calculating with a receiver of a multi-antenna communication system an average SINR per allocation unit in a spatial domain by using a certain tuning parameter; based on the calculated average SINR values, calculating an effective SINR through the use of another tuning parameter; and using the calculated effective SINR to determine a corresponding block error rate. Also disclosed is a computer program product that operates in accordance with the method, a receiver, a circuit and a link adaptation unit usable in a MIMO communication system.

### TECHNICAL FIELD

The exemplary and non-limiting embodiments of this invention relate generally to wireless communication systems, methods, apparatus, devices and computer program products and relate to those types of systems known as multi-input, multiple-output (MIMO) systems having multiple antennas.

### BACKGROUND

The following abbreviations are herewith defined:

### 3GPP third generation partnership project

### AGWN additive white Gaussian noise

### BLER block error rate

### BS base station (referred to as a Node B in LTE)

### DL downlink

### EESM exponential effective SINR metric

### FECC forward error correcting code

### LMMSE linear minimum mean squared error

### LTE long term evolution

### OFDM orthogonal frequency division multiplexing

### MIESM mutual information effective SINR metric

### MIMO multiple input, multiple output

### ML maximum likelihood

### QAM quadrature amplitude modulation

### QPSK quadrature phase shift keying

### RB resource block

### SC-FDMA single carrier, frequency division multiple access

### SCME enhanced spatial channel model

### SINR signal-to-interference and noise ratio

### SISO single input, single output

### UE user equipment

### UL uplink

### UTRAN universal terrestrial radio access network

### WCDMA wideband code division multiple access

A proposed communication system known as evolved UTRAN (E-UTRAN, also referred to as UTRAN-LTE) is currently under discussion within the 3GPP. The current working assumption is that the DL access technique will be OFDM, and the UL technique will be SC-FDMA.

In the LTE DL, the general assumption is that active sub-carriers (tentatively 600 active sub-carriers in a 10 MHz bandwidth) are divided into a number of RBs. For example, there may be 24 RBs each having 25 sub-carriers in the 10 MHz system.

Of concern in such a communication system with multiple antenna receivers and transmitters is MIMO link adaptation. A transmission method or format in this context represents a combination of FECC, the symbol modulation technique and the spatial transmission method, such as spatial multiplexing or the use of an Alamouti code (S. M. Alamouti, “A simple transmitter diversity scheme for wireless communications”, IEEE J. Select. Area Commun., vol. 16, pp. 1451-1458, October 1998). A problem that arises in this context is how to select the transmission scheme for a certain allocation unit when the channel and/or interference conditions are changing within the unit. A simple example involves selecting the transmission format for an allocation unit having some certain amount of allocated sub-carriers of one OFDM symbol. When the allocated bandwidth is larger than the coherence bandwidth of the channel, the channel cannot be assumed to be constant over the allocated sub-carriers.

As may be appreciated, an important task to be accomplished during the selection of the transmission format is to accurately predict an error behavior of all the possible candidate combinations as a function of the multi-state channel described above. Hence, a problem encountered when considering link adaptation is a so-called “link to system (L2S) interface”, which is an abstraction used in system simulations to model the error behavior of a single radio link. In general, a good link adaptation strategy provides a good link to system interface, and vice versa.

In the SISO (single antenna) case the current state of the art link adaptation is based on compressing the varying channel and interference quantities to a single quantity, a so-called effective SINR. Reference with respect to the current state of the art for the SISO case may be had to, as non-limiting examples, 3GPP, R1-060306, NTT DoCoMo et al. “Link Adaptation Scheme for Single-antenna Transmission in E-UTRA Downlink”, 3GPP, R1-060039, NTT DoCoMo et al., “Adaptive Modulation and Channel Coding Rate Control for Single-antenna Transmission in Frequency Domain Scheduling in E-UTRA Downlink”, 3GPP, R1-060101, Ericsson, “Link Adaptation for E-UTRA Downlink”, and 3GPP, R1-060142, Intel, “Further Comparisons between Chunk-Common and Chunk-Dependent Adaptive Modulation using Mutual Information”.

More specifically, let SINRₚ, p=1, . . . , P, denote the P SINR values for an allocation unit. The effective SINR for a certain modulation m and code rate r is calculated as

$${SINR}_{eff , m , r} = {β}_{m , r} {I}_{m}^{- 1} ( \frac{1}{P} {\sum }_{p = 1}^{P} {I}_{m} ( {SINR}_{p} / {β}_{m , r} ) ) ,$$

where Iₘ is a (possibly) modulation dependent invertible function and β_{m,r} is a modulation and coding dependent tuning constant. The effective SINR values are mapped to packet error probabilities via a lookup table, and a preferred modulation and channel code rate combination is chosen according to a suitable criterion, e.g., the predicted throughput.

In general, and with regard to the link to system interface case of a 2×2 antenna configuration and a 2-stream transmission, the LMMSE case straightforward: calculate two SINR values per channel using LMMSE formula; and use EESM-based or MIESM-based SISO mapping.

However, the ML receiver or approximative ML receiver (e.g., QRD-M) is not so straightforward.

In case of multiple receive and transmit antennas, link adaptation has been considered for frequency flat constant channel. For example, reference may be made to O. Tirkkonen, M. Kokkonen and K. Kalliojärvi, “Packet Throughput of Adaptive Matrix Modulation”, Fifth IEE International conference on mobile communication technologies (3G2004), London, October 2004, pp. 11-15. For the case of the varying channel, the dual problem of the link to system interface has been studied in K. Brueninghaus, D Astely, T. Sälzer, S. Visuri, A. Alexiou and S. Karger, “Link Performance Models for System Level Simulations of Broadband Radio Access”, IEEE PIMRC 2005, Berlin, September 2005. In this case the approach is based on calculating the effective SINR as

$${SINR}_{eff , m , r , s} = {β}_{m , r} {I}_{m}^{- 1} ( \frac{1}{{PN}_{s}} {\sum }_{p = 1}^{P} {\sum }_{l = 1}^{{N}_{s}} {I}_{m} ( {SINR}_{p , l , s} / {β}_{m , r} ) ) \qquad ( 1 )$$

where Iₘ and β_{m,r} are as above, SINR_{p,l,s} are the spatial transmission method-specific MMSE receiver SINR values of the l:th data stream at the p:th location within the allocation unit, and Nₛ is the number of independent data streams associated with spatial transmission method s. This may be referred to as a one parameter approach to calculating the effective SINR.

### SUMMARY

The exemplary embodiments of this invention provide in a first aspect thereof a method that comprises: A) for a selected modulation type and coding rate, calculating with a receiver of a multi-antenna communication system an average SINR per allocation unit in a spatial domain by using a certain tuning parameter; B) based on the calculated average SINR values, calculating an effective SINR through the use of another tuning parameter; and C) using the calculated effective SINR to determine a corresponding block error rate.

The exemplary embodiments of this invention provide in another aspect thereof a computer program product stored in a tangible memory medium and comprising instructions, that when executed by a data processor, result in operations that comprise: A) for a selected modulation type and coding rate, calculating with a receiver of a multi-antenna communication system an average SINR per allocation unit in a spatial domain by using a certain tuning parameter; B) based on the calculated average SINR values, calculating an effective SINR through the use of another tuning parameter; and C) using the calculated effective SINR to determine a corresponding block error rate.

The exemplary embodiments of this invention provide in a further aspect thereof a receiver adapted for use in a MIMO communication system. The receiver comprises a link adaptation module that is responsive to a selected modulation type and coding rate to calculate an average SINR per allocation unit in a spatial domain by using a certain tuning parameter and, based on the calculated average SINR values, to further calculate an effective SINR through the use of another tuning parameter. The link adaptation module is further adapted to use the calculated effective SINR to determine a corresponding block error rate.

The exemplary embodiments of this invention provide in a still further aspect thereof a circuit that is responsive to a selected modulation type and coding rate for a MIMO radio frequency communication system. The circuit is adapted to determine an average SINR per allocation unit in a spatial domain by using a certain tuning parameter and, based on calculated average SINR values, to further determine an effective SINR through the use of another tuning parameter. The circuit is further adapted to determine a corresponding block error rate through use of the calculated effective SINR.

The exemplary embodiments of this invention provide in yet another aspect thereof a link adaptation unit that comprises a component of a multi-antenna receiver that receives signals from a multi-antenna transmitter through a channel. The link adaptation unit comprises means, responsive to a selected modulation type and coding rate, for calculating an average SINR per allocation unit in a spatial domain by using a certain tuning parameter and, responsive to the calculated average SINR values, for calculating determining an effective SINR through the use of another tuning parameter. The link adaptation unit further includes means for determining a corresponding block error rate through use of the calculated effective SINR.

### BRIEF DESCRIPTION OF THE DRAWINGS

In the attached Drawing Figures:

FIG. 1 is a block diagram of a MIMO-OFDM system in which the exemplary embodiments of this invention may be implemented.

FIG. 2 is a logic flow diagram that is illustrative of the exemplary embodiments of this invention.

FIGS. 3 and 4 are graphs obtained from simulations of conventional EESM that plot effective SINR versus BLER for a low modulation, low coding rate case and for a higher modulation, higher coding rate case, respectively.

FIG. 5 is a graph obtained from simulations of a two dimensional EESM case, in accordance with exemplary embodiments of this invention, for the higher modulation order, higher coding rate case of FIG. 4, and show the significant improvement in performance that is realized.

### DETAILED DESCRIPTION

The exemplary embodiments of this invention are particularly useful in a communication system with a multi-antenna base station (e.g., 2 antennas) and multi-antenna (e.g., two antennas) user equipment such as, but not limited to, the above-mentioned E-UTRAN system being standardized in WCDMA long term evolution. The use of the exemplary embodiments of this invention improves the selection of an optimum transmission method for such a communication system with multi-antenna receivers and transmitters, and thus facilitates the MIMO link adaptation process.

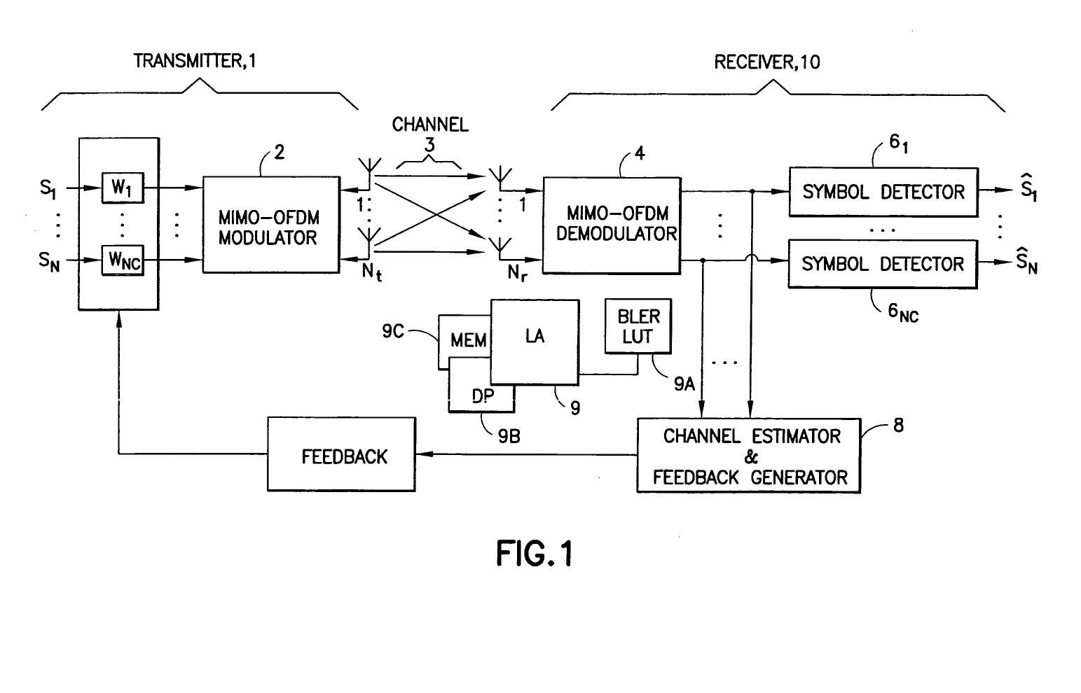

FIG. 1 shows a generalized and non-limiting architectural model of a MIMO-OFDM system within which the exemplary embodiments of this invention may be employed. The system shown in FIG. 1 assumes a multi-antenna wireless communication system with Nₜ transmit antennas and Nᵣ receive antennas, where OFDM that utilizes N_{c} sub-carriers is employed per antenna transmission. At a transmitter 1, such as a BS, one may assume the presence of information symbols s₁, s₂, . . . , s_{Nc}, which are modified by a beamforming weight vector expressed as w₁, w₂, . . . , w_{Nc} and applied to a MIMO-OFDM modulator 2 for transmission through a channel 3 by the Nₜ transmit antennas. The transmitted signals are received at a receiver 10, such as a UE, by the Nᵣ receive antennas and are applied to a MIMO-OFDM demodulator 4. The outputs of the MIMO-OFDM demodulator 4 are applied to symbol detectors 6₁, 6₂, . . . , 6_{Nc} to recover, ideally, the input information symbols s₁, s₂, . . . , s_{Nc}. At the output of the MIMO-OFDM demodulator 4 is a channel estimator and feedback generator 8 that generates a feedback signal 9 to the transmitter 1. Based on the feedback, the transmitter 1 seeks to match the beamforming vector (expressed as weights w₁, w₂, . . . , w_{Nc}) to the channel 3 to improve the system performance.

In accordance with the exemplary embodiments of this invention, and as will be discussed in detail below, the receiver 10 includes a link adaptation (LA) module 9 that operates in accordance with a multi-parameter effective SINR approach, as opposed to a conventional single parameter SINR approach, such as the one detailed above in Eq. (1).

Note that FIG. 1 also shows a BLER lookup table (LUT) 9A associated with the LA module 9, as described below, as well as a data processor (DP) 9B and associated memory (MEM) 9C. In practice, the LUT 9A may form a part of the memory 9C.

In general, the various embodiments of the receiver 10 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

It should be noted that in other embodiments of the invention the transmitter 1 may be the LE, and the receiver 10 may be the BS.

The exemplary embodiments of this invention may be implemented by computer software executable by DP 9B of the receiver 10, or by hardware, or by a combination of software and hardware.

The exemplary embodiments of this invention pertain at least in part to the operation of the LA 9.

The exemplary embodiments of this invention calculate the effective SINR for link adaptation by using two modulation and coding dependent tuning parameters β_{m,r,1} and β_{m,r,2} instead of the one tuning parameter applied in Eq. (1).

In this way the effective SINR is calculated in two steps:

$$\begin{matrix}{SINR}_{p , m , r , s} = {β}_{m , r , 1} {I}_{m , 1}^{- 1} ( \frac{1}{{N}_{s}} {\sum }_{l = 1}^{{N}_{s}} {I}_{m , 1} ( {SINR}_{p , l , s} / {β}_{m , r , 1} ) ) , p = 1 , … , P & 1 ) \\ {SINR}_{eff , m , r , s} = {β}_{m , r , 2} {I}_{m , 2}^{- 1} ( \frac{1}{P} {\sum }_{p = 1}^{P} {I}_{m , 2} ( {SINR}_{p , m , r , s} / {β}_{m , r , 2} ) ) , & 2 )\end{matrix}$$

where I_{m,1} and I_{m,2} are (possibly) modulation dependent invertible functions and SINR_{p,l,s} are as in Eq. (1) (but do not necessary have to be computed according to the MMSE formulation). Step 1) calculates an average SINR in the spatial domain, whereas step 2) performs averaging over the resource blocks. In that two different tuning parameters are used, and in that the two dimensions are considered individually, this approach can be shown to significantly improves the performance as compared to the one parameter approach given in Eq. (1).

Explaining now in further detail, for the case of a 2 Tx and 2 Rx antenna system and a LMMSE SINR calculation, assume a signal model given by:

yₖ=Hₖsₖ+vₖ,

where k is the subcarrier index, Hₖ=[h_{1,k} h_{2,k}] is the 2×2 channel matrix, sₖ is the 2×1 transmitted signal vector, E{sₖsₖ^{H}}=(½)I₂, vₖ represents noise, and E{vₖvₖ^{H}}=σ²I₂.

For the LMMSE receiver W^{H}=[w₁ w₂]^{H}=Hₖ^{H}(HₖHₖ^{H}+2σ²I₂)⁽⁻¹⁾, and the combined signal is given by zₖ=Wₖ^{H}yₖ.

The resulting SINR for stream 1 is then given by:

SINR_{1,k}=|w₁^{H}h₁|²/(|w₁^{H}h₂|²+2σ²∥w₁∥²), and

the SINR for stream 2 is given by:

SINR_{2,k}=w₂^{H}h₂|²/(|w₂^{H}h₁|²+2σ²∥w₂∥²).

Exemplary simulation and modeling parameters of interest may include the following:

### 10 MHz OFDM parameters, packet size equal to 1 OFDM symbol

### Channel Models: AWGN

### ITU Pedestrian B

### Vehicular A

### QRD-M receiver with M=32

### QPSK 16-QAM and 64-QAM modulations

### Ideal channel estimation and interleaving.

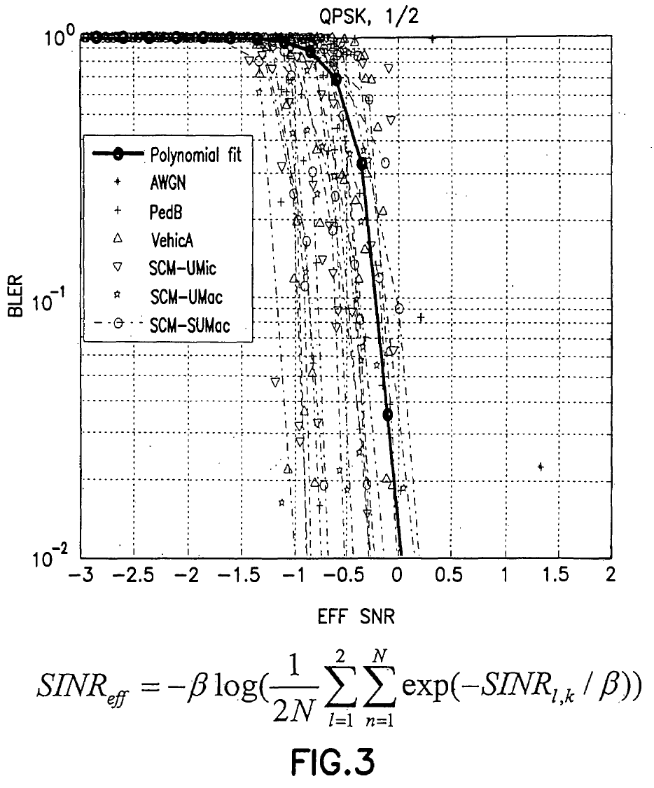

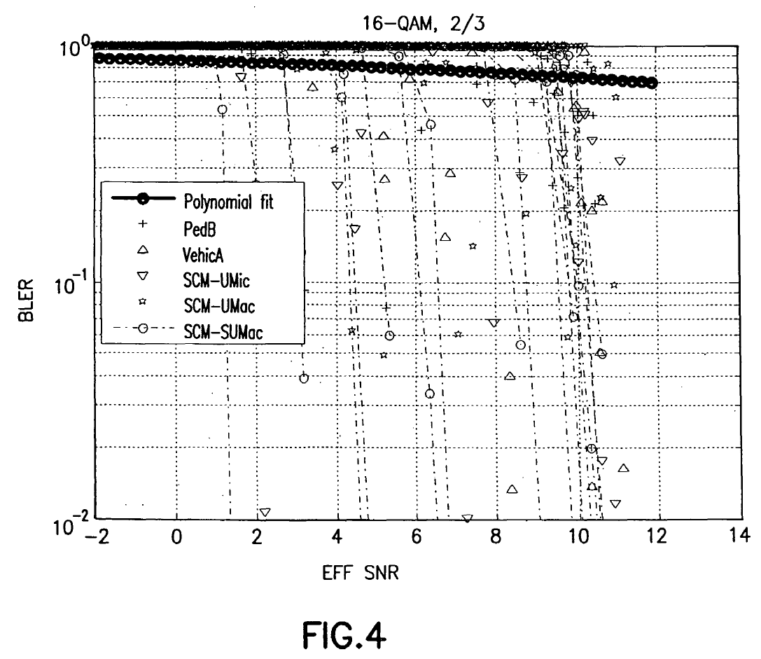

The effective SINR, considering a case of conventional EESM, can be obtained by use of the expression shown with the graph of FIG. 3, where it can be observed the EESM functions relatively well for low modulation order and coding rates (QPSK, rate 1/2 in this example), and that a large gap exits between AWGN and other channel models due to the spatial structure of the AWGN channel. However, it can be observed in the graph of FIG. 4 that conventional EESM (or MIESM), with a higher modulation order and coding rate (e.g., 16-QAM, rate 2/3) does not predict the error behavior. Although not illustrated, poor performance is also observed for the 64-QAM case, as well as for QPSK with code rate 2/3.

The various exemplary channel models in FIGS. 3 and 4 (and 5), in addition to the AWGN model, include ITU Pedestrian B, Vehicular A and SCME Urban Micro, Urban Macro and Suburban Macro.

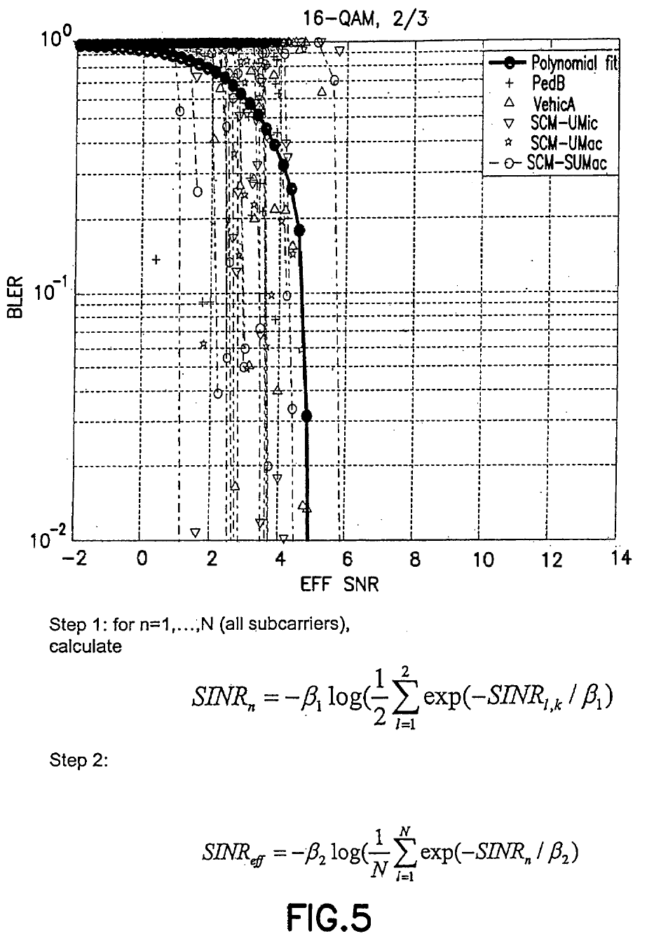

FIG. 5 is a graph obtained from simulations of a two dimensional ESSM case, in accordance with exemplary embodiments of this invention, for the higher modulation order, higher coding rate case of FIG. 4 (16-QAM, rate 2/3), and shows the significant improvement in performance that is realized using the two-step procedure to compute the effective SINR. One can readily note the more pronounced spatial structure in FIG. 5 versus FIG. 4 that is achieved by the use of two fitting parameters (β₁=0.917, β₂=0.488 in this example), as compared to the single fitting parameter (β=200) in FIG. 4.

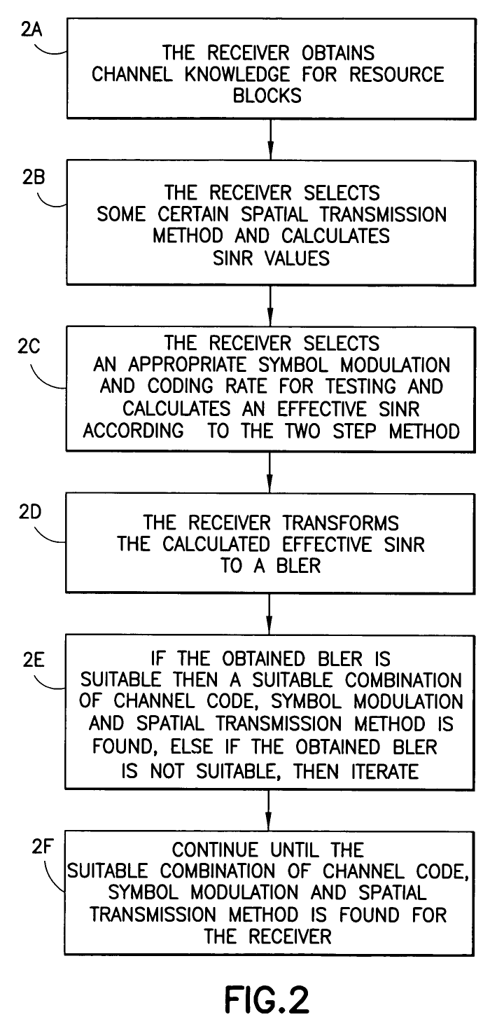

In the exemplary implementation in the DL is illustrated in the logic flow diagram of FIG. 2, and thus assuming that the receiver 10 of FIG. 1 is a UE, operates as follows:

Block 2A) The receiver 10 obtains channel knowledge for resource blocks p=1, . . . , P and thereby obtains the channel coefficients.

Block 2B) The receiver 10 selects some certain spatial transmission method s and calculates the SINR values SINR_{p,l,s} by using, e.g., MMSE SINR formulas.

Block 2C) The receiver 10 selects an appropriate symbol modulation and coding rate for testing and calculates an effective SINR according to the two step method discussed above, i.e.,

$$\begin{matrix}{SINR}_{p , m , r , s} = {β}_{m , r , 1} {I}_{m , 1}^{- 1} ( \frac{1}{{N}_{s}} {\sum }_{l = 1}^{{N}_{s}} {I}_{m , 1} ( {SINR}_{p , l , s} / {β}_{m , r , 1} ) ) , p = 1 , … , P & step 1 ) \\ {SINR}_{eff , m , r} = {β}_{m , r , 2} {I}_{m , 2}^{- 1} ( \frac{1}{P} {\sum }_{p = 1}^{P} {I}_{m , 2} ( {SINR}_{p , m , r , s} / {β}_{m , r , 2} ) ) , . & step 2 )\end{matrix}$$

Block 2D) The receiver 10 transforms the calculated effective SINR to a BLER using, for example, a lookup table (LUT) 9A as shown in FIG. 1. The BLER values stored in the LUT 9A for different modulation types and coding rates can be obtained by simulations, such as in the example of FIG. 5 for the 16-QAM, rate 2/3 case, and then indexed by the effective SNR values.

Block 2E) If the obtained BLER is not suitable for use, such as by not meeting a desired QoS requirement or requirements (e.g., a throughput criterion), the method may iterate, such as by the receiver 10 first going back to Block 2C and, if needed, then back to Block 2B.

Block 2F) This process continues until a suitable combination of channel code, symbol modulation and spatial transmission method is found that yields a desired BLER.

The various blocks shown in FIG. 2 may be viewed as method steps, and/or as operations that result from operation of computer program code, and/or as a plurality of coupled logic circuit elements constructed to carry out the associated function(s).

Based on the foregoing description it should be appreciated that there are a number of advantages that are realized by the use of the exemplary embodiments of this invention. For example, improved accuracy of the link quality prediction (improved error probability) is achieved, leading to improved system performance and accuracy of link adaptation. As another example, the predicted BLER probability can be used for adapting the link transmission scheme, modulation and transmission power, as non-limiting examples, enabling an increase to be realized in throughput with a decrease in power consumption and in system interference. Further, the exemplary embodiments of the link adaptation mechanism and method described above improve the mapping from channel and interference conditions to packet error probability for non-linear receivers and for high order modulations and, in general, solves a difficult problem that arises with the use of a non-linear multi-stream MIMO detector.

Exemplary features of these disclosed non-limiting embodiments include the prediction of the (block) error probability of a multiple stream and/or multiple channel transmission based on elementary SINR values of the streams/channels, and the use of an enhanced link adaptation process that is based at least in part on the SINR of resource blocks.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. For example, and as was noted above, certain aspects of the exemplary embodiments of this invention may be implemented by the DP 9B when executing program code stored in the memory 9C.

While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions, such as all or part of the LA module 9 of FIG. 1, may be embodied in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method comprising:
A) for a selected modulation type and coding rate, calculating with a receiver of a multi-antenna communication system an average SINR per allocation unit in a spatial domain by using a certain tuning parameter;
B) based on the calculated average SINR values, calculating an effective SINR through the use of another tuning parameter; and
C) using the calculated effective SINR to determine a corresponding block error rate.

2. The method of claim 1, where step B calculates the average over the allocation units and where step C operates over the spatial domain.

3. The method of claim 1, where the calculating steps comprise calculating the effective SINR for use in link adaptation by the use of two modulation and coding dependent tuning parameters β_{m,r,1} and β_{m,r,2}, by a first calculation:
$${SINR}_{p , m , r , s} = {β}_{m , r , 1} {I}_{m , 1}^{- 1} ( \frac{1}{{N}_{s}} {\sum }_{l = 1}^{{N}_{s}} {I}_{m , 1} ( {SINR}_{p , l , s} / {β}_{m , r , 1} ) ) , p = 1 , … , P$$
and by a second calculation:
$${SINR}_{eff , m , r} = {β}_{m , r , 2} {I}_{m , 2}^{- 1} ( \frac{1}{P} {\sum }_{p = 1}^{P} {I}_{m , 2} ( {SINR}_{p , m , r , s} / {β}_{m , r , 2} ) ) ,$$
where SINRₚ, p=1, . . . , P, denote the P SINR values for an allocation unit, m is a certain modulation, r is code rate, and I_{m,1} and I_{m,2} are (possibly) modulation dependent invertible functions.

4. The method of claim 1, where the determined corresponding block error rate is compared to a desired block error rate, and further comprising selecting at least one of a different modulation type and coding rate if the determined corresponding block error rate does not meet the desired block error rate, and again executing steps A, B and C.

5. The method of claim 1, where the multi-antenna communication system comprises a MIMO communication system having a transmitter with two antennas, and where the receiver comprises two antennas.

6. A computer program product stored in a tangible memory medium and comprising instructions, that when executed by a data processor, result in operations that comprise:
A) for a selected modulation type and coding rate, calculating with a receiver of a multi-antenna communication system an average SINR per allocation unit in a spatial domain by using a certain tuning parameter;
B) based on the calculated average SINR values, calculating an effective SINR through the use of another tuning parameter; and
C) using the calculated effective SINR to determine a corresponding block error rate.

7. The computer program product of claim 6, where operation B comprises calculating the average over the allocation units and where operation C comprises operating over the spatial domain.

8. The computer program product of claim 6, where the calculating operations comprise calculating the effective SINR for use in link adaptation by the use of two modulation and coding dependent tuning parameters β_{m,r,1} and β_{m,r,2}, by a first calculation:
$${SINR}_{p , m , r , s} = {β}_{m , r , 1} {I}_{m , 1}^{- 1} ( \frac{1}{{N}_{s}} {\sum }_{l = 1}^{{N}_{s}} {I}_{m , 1} ( {SINR}_{p , l , s} / {β}_{m , r , 1} ) ) , p = 1 , … , P$$
and by a second calculation:
$${SINR}_{eff , m , r} = {β}_{m , r , 2} {I}_{m , 2}^{- 1} ( \frac{1}{P} {\sum }_{p = 1}^{P} {I}_{m , 2} ( {SINR}_{p , m , r , s} / {β}_{m , r , 2} ) ) ,$$
where SINRₚ, p=1, . . . , P, denote the P SINR values for an allocation unit, m is a certain modulation, r is code rate, and I_{m,1} and I_{m,2} are (possibly) modulation dependent invertible functions.

9. The computer program product of claim 6, further comprising operations of comparing the determined corresponding block error rate to a desired block error rate, and further selecting at least one of a different modulation type and coding rate if the determined corresponding block error rate does not meet the desired block error rate, and again executing the operations A, B and C.

10. The computer program product of claim 6, where the multi-antenna communication system comprises a MIMO communication system having a transmitter with two antennas, and where the receiver comprises two antennas.

11. A receiver adapted for use in a MIMO communication system and comprising a link adaptation module responsive to a selected modulation type and coding rate, to calculate an average SINR per allocation unit in a spatial domain by using a certain tuning parameter and, based on the calculated average SINR values, to further calculate an effective SINR through the use of another tuning parameter; said link adaptation module further adapted to use the calculated effective SINR to determine a corresponding block error rate.

12. The receiver of claim 11, said link adaptation module calculates the average SINR over the allocation units and uses the calculated effective SINR to determine the corresponding block error rate over the spatial domain.

13. The receiver of claim 11, where said link adaptation module is adapted to calculate the effective SINR by use of two modulation and coding dependent tuning parameters β_{m,r,1} and β_{m,r,2}, by a first calculation:
$${SINR}_{p , m , r , s} = {β}_{m , r , 1} {I}_{m , 1}^{- 1} ( \frac{1}{{N}_{s}} {\sum }_{l = 1}^{{N}_{s}} {I}_{m , 1} ( {SINR}_{p , l , s} / {β}_{m , r , 1} ) ) , p = 1 , … , P$$
and by a second calculation:
$${SINR}_{eff , m , r} = {β}_{m , r , 2} {I}_{m , 2}^{- 1} ( \frac{1}{P} {\sum }_{p = 1}^{P} {I}_{m , 2} ( {SINR}_{p , m , r , s} / {β}_{m , r , 2} ) ) ,$$
where SINRₚ, p=1, . . . , P, denote the P SINR values for an allocation unit, m is a certain modulation, r is code rate, and I_{m,1} and I_{m,2} are (possibly) modulation dependent invertible functions.

14. The receiver of claim 111 said link adaptation module further adapted to compare the determined corresponding block error rate to a desired block error rate, to select at least one of a different modulation type and coding rate if the determined corresponding block error rate does not meet the desired block error rate, and to again calculate the average SINR and the effective SINR.

15. The receiver of claim 11, further comprising a lookup table coupled to the link adaptation module, the lookup table storing a plurality of block error rates indexed by calculated effective SINRs for a plurality of different modulation types and coding rates.

16. The receiver of claim 11, where said link adaptation module is embodied at least partially in one or more integrated circuit modules.

17. The receiver of claim 11, where the MIMO communication system comprises a transmitter with at least two antennas, and where the receiver comprises at least two antennas.

18. A circuit responsive to a selected modulation type and coding rate for a MIMO radio frequency communication system and adapted to determine an average SINR per allocation unit in a spatial domain by using a certain tuning parameter and, based on calculated average SINR values, to further determine an effective SINR through the use of another tuning parameter, said circuit further adapted to determine a corresponding block error rate through use of the calculated effective SINR.

19. The circuit of claim 18 adapted to calculate the average SINR over the allocation units and to use the calculated effective SINR to determine the corresponding block error rate over the spatial domain.

20. The circuit of claim 18 adapted to calculate the effective SINR using two modulation and coding dependent tuning parameters β_{m,r,1} and β_{m,r,2}, by a first calculation:
$${SINR}_{p , m , r , s} = {β}_{m , r , 1} {I}_{m , 1}^{- 1} ( \frac{1}{{N}_{s}} {\sum }_{l = 1}^{{N}_{s}} {I}_{m , 1} ( {SINR}_{p , l , s} / {β}_{m , r , 1} ) ) , p = 1 , … , P$$
and by a second calculation:
$${SINR}_{eff , m , r} = {β}_{m , r , 2} {I}_{m , 2}^{- 1} ( \frac{1}{P} {\sum }_{p = 1}^{P} {I}_{m , 2} ( {SINR}_{p , m , r , s} / {β}_{m , r , 2} ) ) ,$$
where SINRₚ, p=1, . . . , P, denote the P SINR values for an allocation unit, m is a certain modulation, r is code rate, and I_{m,1} and I_{m,2} are (possibly) modulation dependent invertible functions.

21. The circuit of claim 18 further adapted to compare the determined corresponding block error rate to a desired block error rate, to select at least one of a different modulation type and coding rate if the determined corresponding block error rate does not meet the desired block error rate, and to again calculate the average SINR and the effective SINR.

22. The circuit of claim 18, further adapted to be coupled to a memory that stores a plurality of block error rates indexed by calculated effective SINRs for a plurality of different modulation types and coding rates.

23. The circuit of claim 18 embodied at least partially in at least one integrated circuit.

24. The circuit of claim 18 embodied in a link adaptation unit of a receiver.

25. The circuit of claim 24 where the MIMO communication system comprises a transmitter with at least two antennas, and where the receiver comprises at least two antennas.

26. A link adaptation unit, comprising a component of a multi-antenna receiver that receives signals from a multi-antenna transmitter through a channel, said link adaptation unit comprising means, responsive to a selected modulation type and coding rate, for calculating an average SINR per allocation unit in a spatial domain by using a certain tuning parameter and, responsive to the calculated average SINR values, for calculating determining an effective SINR through the use of another tuning parameter; and means for determining a corresponding block error rate through use of the calculated effective SINR.

27. The link adaptation unit of claim 26, where said calculating means is operable for calculating the average SINR over the allocation units, and where said determining means uses the calculated effective SINR for determining the corresponding block error rate over the spatial domain.

28. The link adaptation unit of claim 26, where said calculating means calculates the effective SINR using two modulation and coding dependent tuning parameters β_{m,r,1} and β_{m,r,2}, by a first calculation:
$${SINR}_{p , m , r , s} = {β}_{m , r , 1} {I}_{m , 1}^{- 1} ( \frac{1}{{N}_{s}} {\sum }_{l = 1}^{{N}_{s}} {I}_{m , 1} ( {SINR}_{p , l , s} / {β}_{m , r , 1} ) ) , p = 1 , … , P$$
and by a second calculation:
$${SINR}_{eff , m , r} = {β}_{m , r , 2} {I}_{m , 2}^{- 1} ( \frac{1}{P} {\sum }_{p = 1}^{P} {I}_{m , 2} ( {SINR}_{p , m , r , s} / {β}_{m , r , 2} ) ) ,$$
where SINRₚ, p=1, . . . , P, denote the P SINR values for an allocation unit, m is a certain modulation, r is code rate, and I_{m,1} and I_{m,2} are (possibly) modulation dependent invertible functions.

29. The link adaptation unit of claim 26 further comprising means for comparing the determined corresponding block error rate to a desired block error rate, for selecting at least one of a different modulation type and coding rate if the determined corresponding block error rate does not meet the desired block error rate, and where said calculating means recalculates the average SINR and the effective SINR using the at least one of the different modulation type and coding rate.

30. The link adaptation unit of claim 26 further comprising an interface to a memory that stores a plurality of block error rates indexed by calculated effective SINRs for a plurality of different modulation types and coding rates.

31. The link adaptation unit of claim 26 embodied at least partially in at least one integrated circuit.
